(19) United States
(12) Patent Application Publication
(10) Pub. No.: US 2007/0293098 A1
(43) Pub. Date: Dec. 20, 2007

(54) Stop device for preventing cutting fluid from entering space between male mold and female mold

(75) Inventor: Tom Hsieh, Nan Tou City (TW)

Correspondence Address: CHARLES E. BAXLEY, ESQ., 90 JOHN STREET, THIRD FLOOR, NEW YORK, NY, 10038, US

(73) Assignee: Hardinge Taiwan Ltd.

(21) Appl. No.: 11/455,572

(22) Filed: Jun. 19, 2006

(51) Int. Cl. H01R 13/405

(52) U.S. Cl. 439/736

(57) ABSTRACT

A stop device for processing machine includes an engaging member mounted to a positioning device and has a tapered male mold which extends above the positioning device. A female mold is connected to an underside of the rotatable board and has a recess which is shaped to receive the male mold. A groove is defined in an underside of the female mold and is wide enough to stop cutting fluid from flowing along the female mold and entering the space between the recess of the female mold and the male mold.

### FIELD OF THE INVENTION

The present invention relates to a stop device of a machining center and the stop device prevents the cutting fluid from entering the space between the male and female molds

### BACKGROUND OF THE INVENTION

A conventional processing machine 10 is shown in FIGS. 1 and 2, and generally includes a cylinder 11 which is connected to a rotatable board 12, two platforms 13A, 13B are connected on the rotatable board 12 so that when rotating the rotatable board 12, the two platforms 13A, 13B can be moved between the cutting zone 15A and the loading zone 15B. When the two platforms 13A, 13B are located at stationary positions, they are positioned by two positioning devices 14A, 14B. Each of the positioning devices 14A, 14B has a clamp unit 141 so as to clamp the two respective undersides of the two platforms 13A, 13B. When the cylinder 11 lifts the rotatable board 12, the two platforms 13A, 13B are disengaged from the clamp units 141 and another cylinder (not shown) rotates the rotatable board 12 to shift the positions of the two platforms 13A, 13B. However, during cutting, the mixture of debris “S” and cutting fluid “L” flows along the two platforms 13A, 13B and may drop into the space between the two platforms 13A, 13B and the two positioning devices 14A, 14B. The debris in the space may affect the precision of the engagement between the two platforms 13A, 13B and the two positioning devices 14A, 14B.

The present invention intends to provide a stop device that stops the cutting fluid from entering the space between the male and female molds such that the shortcomings can be improved.

### SUMMARY OF THE INVENTION

The present invention relates to a stop device for processing machine and the stop device comprises an engaging member mounted to a positioning device and has a male mold which extends above the positioning device. A female mold is connected to a rotatable board and has a recess defined therein which faces the male mold. A groove is defined in an underside of the female mold so as to stop cutting fluid from flowing along the female mold.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional processing machine;

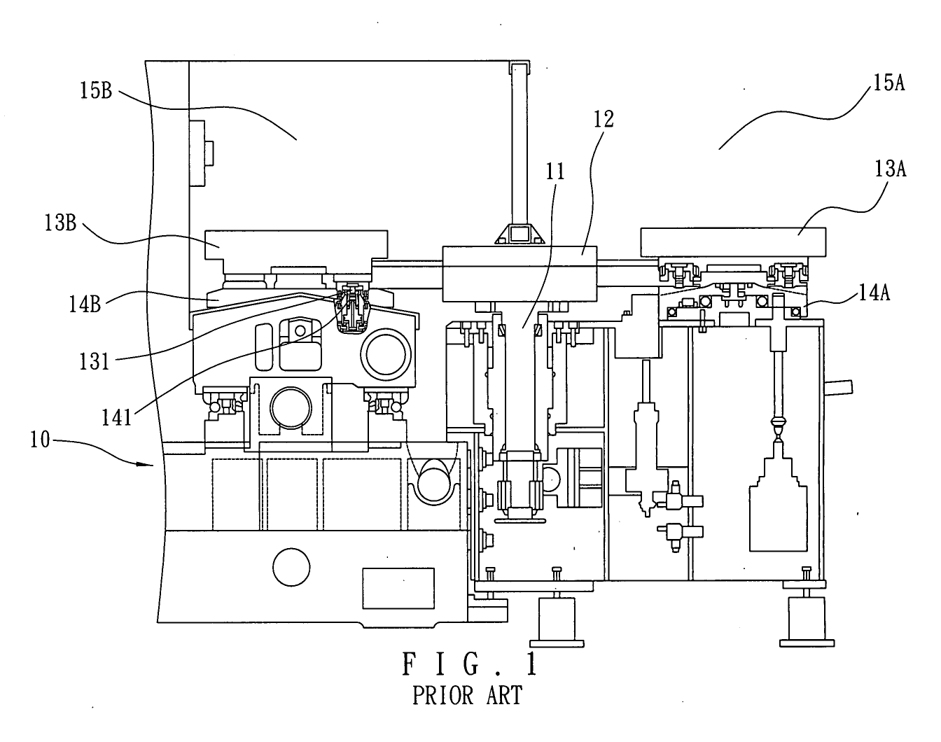

FIG. 2 is an enlarged view to show the mixture of cutting fluid and debris enter the space between the two platforms and the two positioning devices of the conventional processing machine;

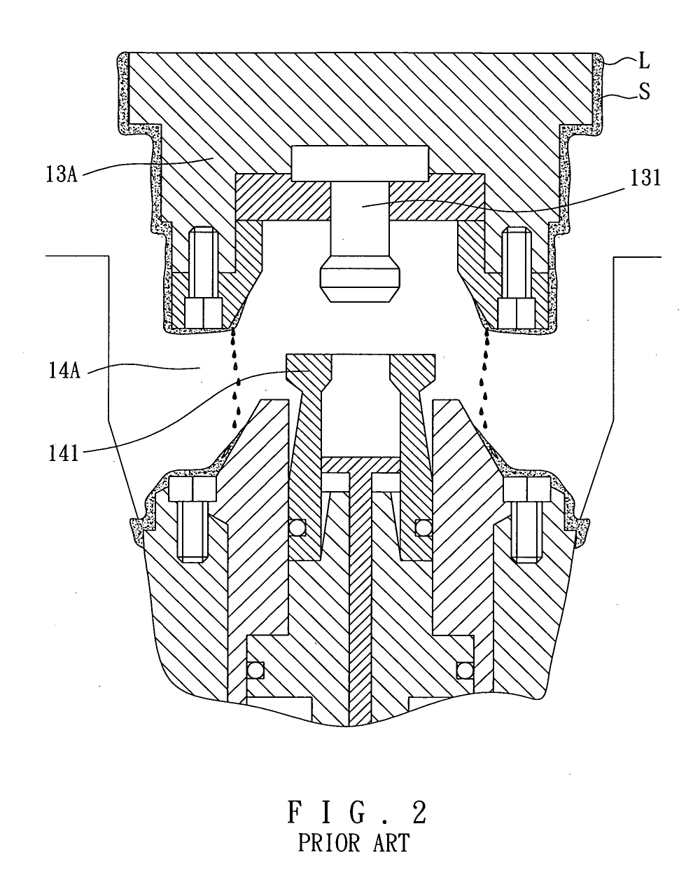

FIG. 3 shows the processing machine with the stop device of the present invention;

FIG. 4 shows that the rotatable board is lifted and the male mold is disengaged from the recess of the female mold, and

FIG. 5 shows that the mixture of cutting fluid and debris is stopped by the groove in the female mold.

### DETAILED DESCRIPTION OF THE PREFERRED EMBODIMENT

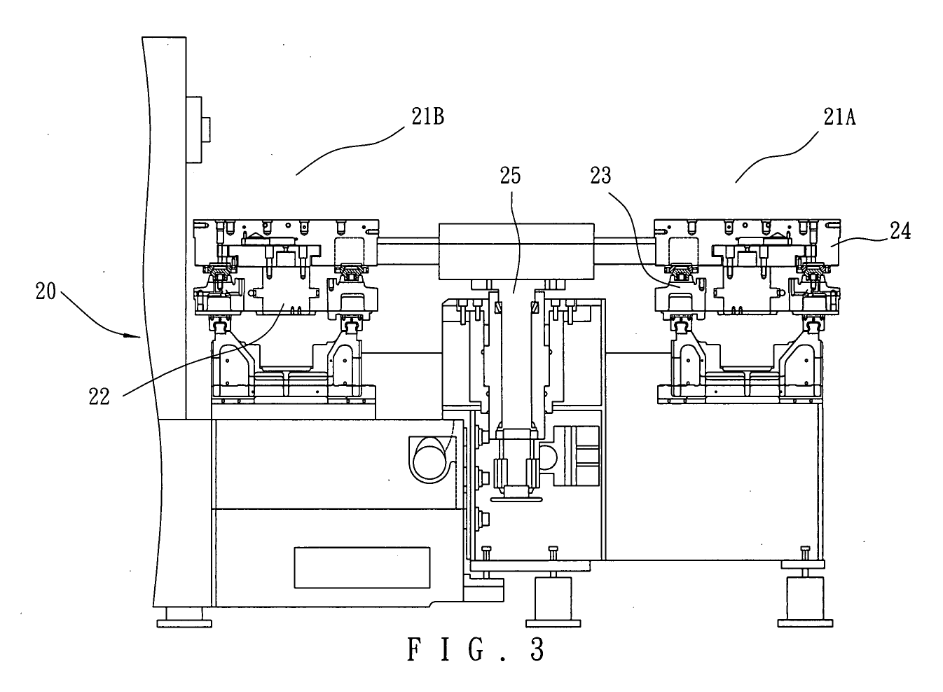

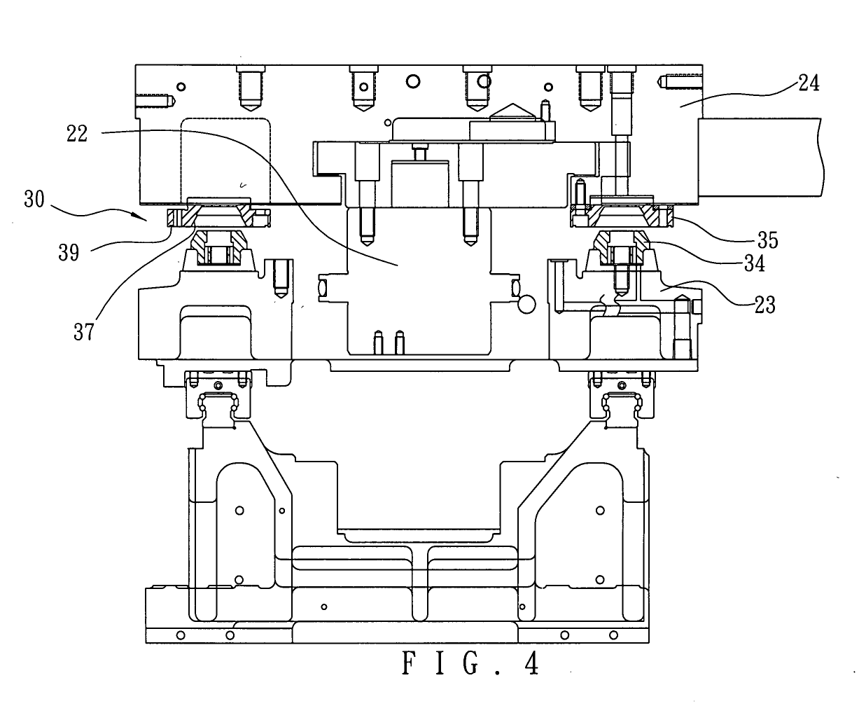

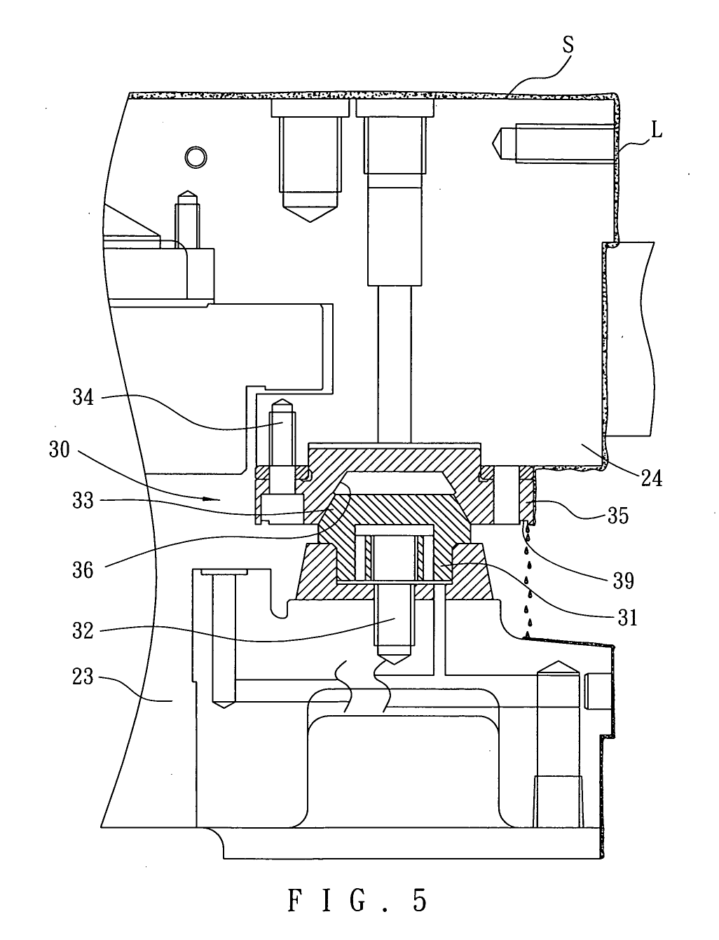

Referring to FIGS. 3 to 5, the processing machine 20 includes a cylinder 22 and a rotatable board 24 is connected to the cylinder 22. A driving device 25 is connected to the rotatable board 24 from another direction so as to rotate the rotatable board 24 to shift the platforms on two ends of the rotatable board 24 between the cutting zone 21A and the loading zone 21B, so that workpieces (not shown) on the platforms on two ends of the rotatable board 24 can be shifted together with the rotation of the rotatable board 24.

The stop device 30 for the processing machine 20 of the present invention comprises an engaging member 31 securely mounted to a positioning device 23 by a fixing member 32 and a male mold 33 connected to the engaging member 31 and extends above the positioning device 23. A female mold 35 is connected to a rotatable board 24 by fixing members 34 and has a recess 36 defined therein which faces the male mold 33. The male mold 33 has a tapered outer periphery and the recess 36 is shaped to match with the protrusion 23, so that when the male mold 3 is engaged with the recess 36, the rotatable board 24 is not rotatable.

A groove 39 is defined in an underside of the female mold 35 and wide enough to stop the mixture of cutting fluid and debris from flowing along the female mold 35 and dropping on the male mold 33. The width of the groove 39 should be width enough to break the surface tension of the mixture of cutting fluid and debris so that it cannot flow over the groove 39 and drops at a position away from the male mold 33.

While we have shown and described the embodiment in accordance with the present invention, it should be clear to those skilled in the art that further embodiments may be made without departing from the scope of the present invention.

What is claimed is:

1. A stop device for processing machine, comprising:
an engaging member mounted to a positioning device and having a male mold which extends above the positioning device, and
a female mold connected to a rotatable board and having a recess defined therein which faces the male mold, a groove defined in an underside of the female mold so as to stop cutting fluid from flowing along the female mold.

2. The device as claimed in claim 1, wherein the male mold has a tapered outer periphery and the recess is shaped to match with the protrusion.
